(19) United States
(12) Patent Application Publication
(10) Pub. No.: US 2009/0182462 A1
(43) Pub. Date: Jul. 16, 2009

(54) Method and system to accelerate aircraft wheels before touch-down

(76) Inventor: Rudolf Hardy Schmitz, Roswel, GA (US)

Correspondence Address: RUDOLF H. SCHMITZ, 2816 HEMINGWAY LANE, ROSWEL, GA, 30075, US

(21) Appl. No.: 12/008,666

(22) Filed: Jan. 14, 2008

(51) Int. Cl. B64C 25/40; G06F 7/00; G06F 19/00

(52) U.S. Cl. 701/3; 244/103 S

(57) ABSTRACT

This invention improves the previous art to accelerate an aircraft's wheels before landing to avoid skidding in that it shows how to (1) provide adequate power by using the compressed air and gases of the jet engine, (2) rely on existing information from onboard systems to precisely control wheel spin and (3) integrate the propulsion device into the wheel structure. The invention minimizes the additional weight necessary to rotate the wheels of a landing aircraft, limits the aerodynamic impact and allows the use of existing tires without modifications.

### CROSS REFERENCE TO RELATED APPLICATIONS

Not Applicable

### STATEMENT REGARDING FEDERALLY SPONSORED RESEARCH OR DEVELOPMENT

No federally sponsored research or development was requested or received.

### REFERENCE TO SEQUENCE LISTING

No material is submitted separately on a compact disk.

### BACKGROUND OF THE INVENTION

The present invention relates generally to aircraft tires and associated methods and devices to rotate a wheel of a landing aircraft prior to the wheel touching the runway. If the wheels of a landing aircraft are not rotating upon impact with the runway, as is currently the case for practically all aircraft, the wheels must accelerate in less than one second to match a landing speed which is in excess of 100 miles per hour for most commercial jets. Until they match this speed, the tires skid over the runway, leaving behind clouds of smoke and rubber deposits in long skid marks. These rubber deposits build up over repeated landings and must be periodically removed. Skidding also results in significant and uneven tire wear which not only makes frequent and costly replacement of tires necessary but also causes undesirable vibrations.

One method of alleviating these problems is to rotate a landing aircraft's wheels prior to touch-down. Various devices have been suggested to achieve this goal.

U.S. Pat. No. 4,385,739 to Soderberg discloses a system wherein there is provided from an aircraft's engines, or other source, a stream of air such that the stream of air is directed against mechanical housings affixed to the wheels of the airborne vehicle, the housings comprising a number of radially spaced surfaces symmetrically positioned about the housings and thus about the wheels of the airborne vehicles such that the stream of air is directed against the radially spaced surfaces imparting to same energy thereby causing the housings and the wheels upon which the housings are mounted to rotate.

U.S. Pat. No. 5,104,063 to Hartley discloses a device to induce rotation of aircraft landing wheels using only the force of oncoming air to bring them up to synchronous ground (landing) speed during approach to landing. A complete, independently operating system with its own sensors, microcontroller, motors and control linkages, which does not interface with any of the aircrafts instrumentation or systems, continually measures the actual ground speed of the aircraft during final approach.

U.S. Pat. No. 5,213,285 to Stanko discloses a modified aircraft tire and an associated landing gear apparatus which rotate a wheel by utilizing the energy of the oncoming air flow. The tire possesses an array of projections which have a forward face for catching air and which are molded into the tire in at least one channel circling the tire tread on at least one sidewall of the tire. A landing gear apparatus which may be used in conjunction with the aircraft tire comprises a duct mounted adjacent to the tire which receives air, reroutes it, and releases it into at least some of the forward faces of the projections.

In spite of these known systems, there remains a need for a commercially acceptable solution that (1) provides a clearly defined and controllable power source, (2) avoids the weight increase associated with duplicate instrumentation and/or propulsion devices, (3) minimizes aerodynamic impact on the aircraft and (4) allows the use of existing tires to avoid an increase in tire inventory as well as additional cost over the entire life of the aircraft due to increased prices for replacement tires.

### BRIEF SUMMARY OF THE INVENTION

This invention improves the previous art to accelerate an aircraft's wheels before landing in that it shows how to (1) provide adequate power by using the compressed air and gases of the jet engine, (2) rely on existing information from onboard systems to precisely control wheel spin and (3) integrate the propulsion device into the wheel structure. The invention minimizes the additional weight necessary to rotate the wheels of a landing aircraft, limits the aerodynamic impact and allows the use of existing tires without modifications.

### BRIEF DESCRIPTION OF DRAWINGS

FIG. 1: Schematic of a jet engine showing the primary point from which compressed air is taken (A) as well as the secondary port for hot gasses (B)

FIG. 2: Basic layout of the invention, showing jet engine, hose, valve and wheel.

FIG. 3: Vertical cross section of the wheel assembly, showing location of hose, nozzle and integrated air foils.

FIG. 4: Horizontal cross section detail, showing several air foils in relation to the nozzle and hose.

### DETAILED DESCRIPTION OF THE INVENTION

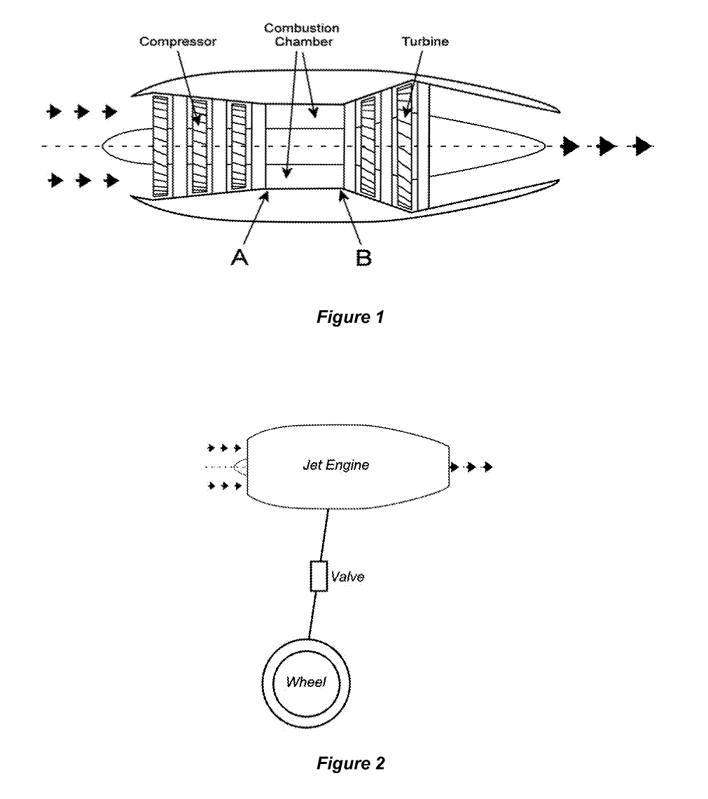

An air/gas line taps into the jet engine between the compressor and the combustion chamber (point A in FIG. 1) to provide power for the wheel spin-up. For high humidity/low temperature conditions, during which icing may occur upon expansion of the compressed air at the end of the line, gas from a second, smaller tap located after the combustion chamber (point B in FIG. 1) is mixed with the compressed air. The fact that the pressure before and after the combustion chamber in a jet engine is the same facilitates such mixing.

A processor-controlled valve situated in the high-pressure line between the jet engine and wheel (FIG. 2) is regulating the flow of air/gas based on the location of the landing gear (up or down), the status of the aircraft (take-off or landing), the ground speed, the distance to the ground, the current rate of wheel spin, typical landing speed and the tire's diameter so that the wheel begins to spin after the landing gear has been lowered and gradually accelerates to a rotational speed commensurate with the aircraft's speed when it finally touches the runway. The valve is closed after touch-down and remains closed until the next landing approach is initiated. All information necessary to calculate and monitor time-to-landing and the appropriate speed build-up is received on a real-time basis through one-way feeds from existing onboard computers, global positioning systems and anti-lock braking devices except for the typical landing speed and the tire's diameter which are one-time entries.

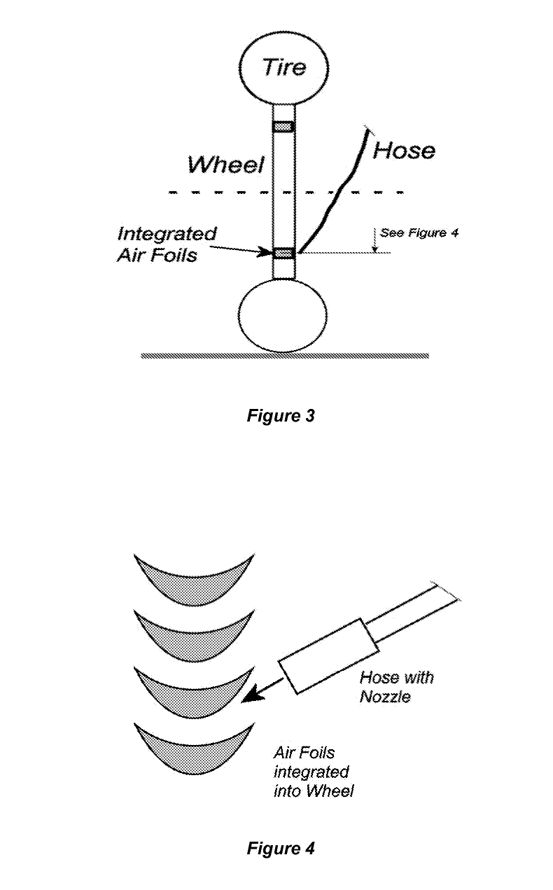

To avoid the additional weight of any attachment to the wheel and any modification of the tire (with the resulting increased inventory requirements and higher tire replacement cost over the life of the aircraft) the spin-up of the wheel is accomplished by directing the compressed air/gas through a nozzle against a multitude of air-foils which are integrated into the wheel structure as shown in FIG. 3 and FIG. 4. Since spokes are often used to lower the weight of a wheel and since the air-foils as shown are similar to spokes, this integration can be accomplished without any increase in weight. Furthermore, the location of the air-foils inside the wheel minimizes their impact on the plane's aerodynamics.

The total additional weight stemming from the implementation of this invention comes from an air hose, a processor, a valve, a nozzle, mounting hardware and some electrical wire.

1. The power to rotate the wheels of a landing aircraft prior to touch-down is provided by utilizing the compressed air available in a jet engine between its compressor and its combustion chamber. Alternately, gas from behind the combustion chamber is mixed with the before mentioned air to prevent icing.

2. Information that is either available from onboard systems, such as computers, global positioning systems and anti-lock braking devices or permanent aircraft specifications, is used via processor to regulate the air/gas flow through a valve to precisely control the wheel spin-up of a landing aircraft before touch-down. No additional instruments are necessary.

3. The airfoils, which transform the power that is provided by pressurized air/gas into the spinning motion of the wheel of a landing aircraft, are integrated into the wheel structure. This eliminates the need to attach any device to the wheel or tire and the associated weight gain.
